(19) United States
(12) Patent Application Publication
(10) Pub. No.: US 2024/0122359 A1
(43) Pub. Date: Apr. 18, 2024

(54) Leg Support Pillow

(71) Applicant: Michael Bevins, Round Rock, TX (US)

(72) Inventor: Michael Bevins, Round Rock, TX (US)

(21) Appl. No.: 17/967,275

(22) Filed: Oct. 17, 2022

(51) Int. Cl. A47C 20/00; A61G 7/075

(52) U.S. Cl. CPC A47C 20/021; A61G 7/0755

(57) ABSTRACT

A leg support pillow for supporting the back of the knee includes a base having a top surface, a bottom surface, a first side surface, and a second side surface. The top surface of the base is abutting and supporting the back of the knee to bend the leg of the user. A prop is attached to the first side surface and extends vertically upwardly to a height dimension greater than a height dimension of the top surface at an apex of the top surface to define a lateral barrier relative to the base. A retention member is attached to the base and the prop to removably extend over the leg to retain the leg on the base.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to support pillows and more particularly pertains to a new support pillow for supporting a back of a person's knee while sleeping.

### (2) Description of Related Art Including Information Disclosed Under 37 CFR 1.97 and 1.98

The prior art relates to support pillows including a variety of pillows configured to support a leg of the user when lying down. Known prior art lacks a support pillow configured for supporting the back of the knee and removably retaining to the leg to provide continuous support when lying down in multiple positions.

### BRIEF SUMMARY OF THE INVENTION

An embodiment of the disclosure meets the needs presented above by generally comprising a base having a top surface, a bottom surface, a first side surface, and a second side surface. The top surface of the base is configured for abutting and supporting the back of the knee to bend the leg of the user. A prop is attached to the first side surface and extends vertically upwardly to a height dimension greater than a height dimension of the top surface at an apex of the top surface to define a lateral barrier relative to the base. A retention member is attached to the base and the prop to removably extend over the leg to retain the leg on the base.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric view of a leg support pillow according to an embodiment of the disclosure.

FIG. 2 is a front view of an embodiment of the disclosure.

FIG. 3 is a side view of an embodiment of the disclosure.

FIG. 4 is an in-use view of an embodiment of the disclosure.

FIG. 5 is an in-use view of an embodiment of the disclosure.

### DETAILED DESCRIPTION OF THE INVENTION

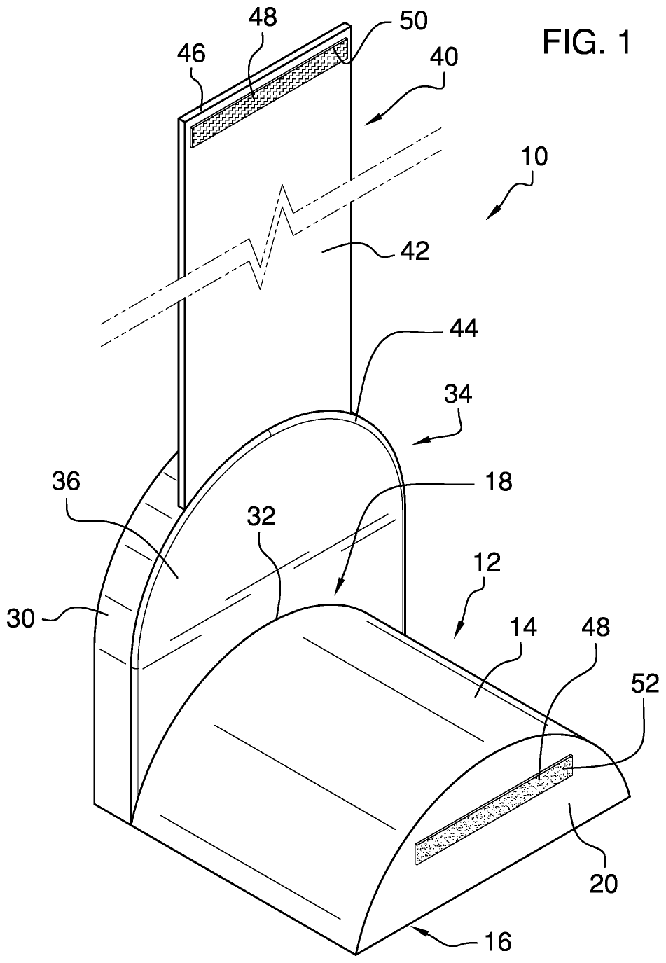

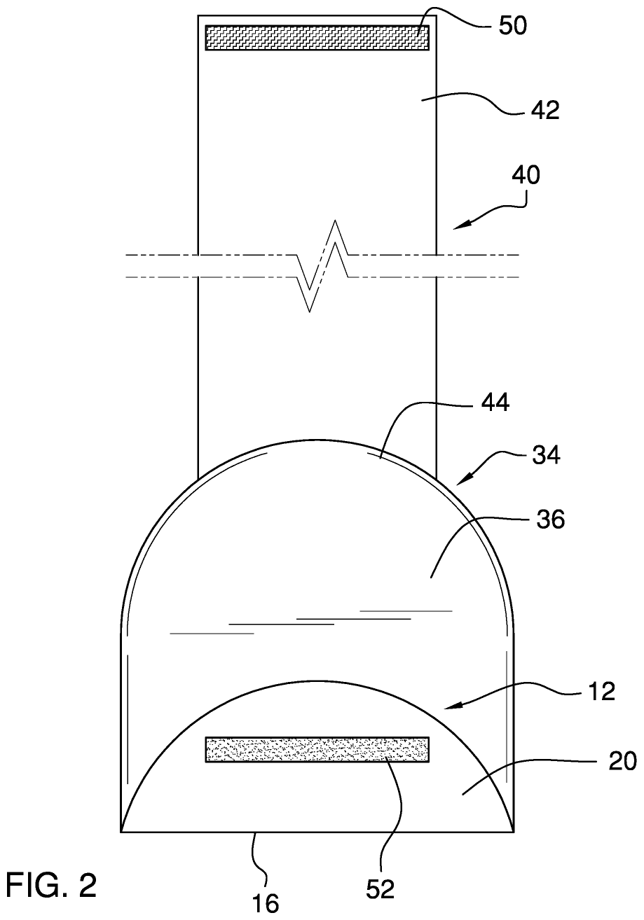

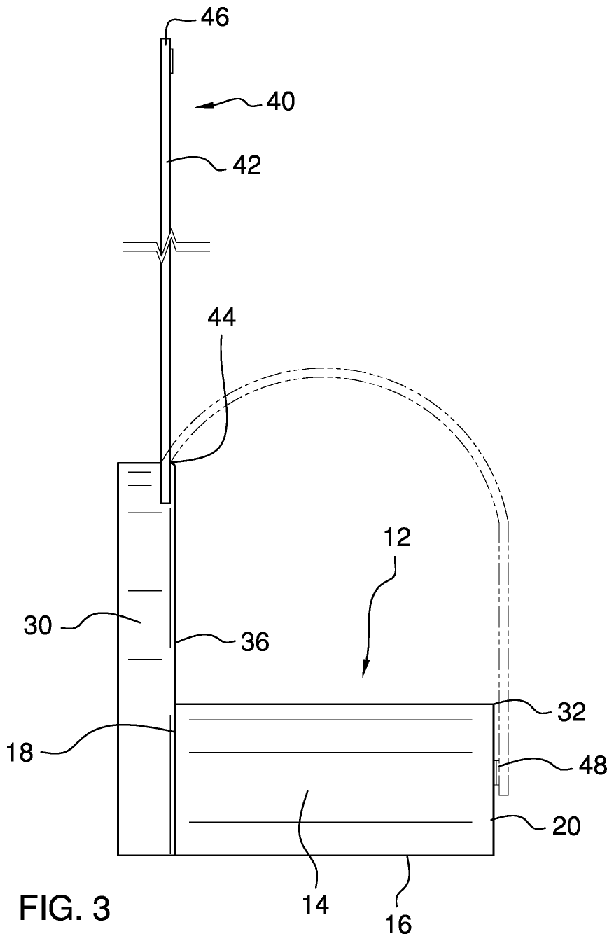

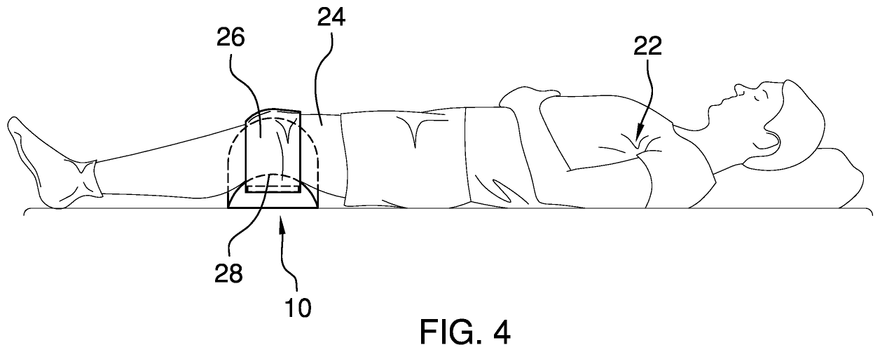

With reference now to the drawings, and in particular to FIGS. 1 through 5 thereof, a new support pillow embodying the principles and concepts of an embodiment of the disclosure and generally designated by the reference numeral 10 will be described.

As best illustrated in FIGS. 1 through 5, the leg support pillow 10 generally comprises a base 12 having a top surface 14, a bottom surface 16, a first side surface 18, and a second side surface 20. The top surface 14 of the base 12 is configured for abutting and supporting the back 28 of the knee 26 to bend the leg 24 of the user 22. The top surface 14 will typically be convexly arcuate and the first 18 and second 20 side surfaces each have a semi-circular shape. The base 12 may comprise a resiliently compressible material or any conventional material used to create pillows. The base 16 may have a length from 6.0 inches to 9.0 inches and a width from 5.0 inches to 8.0 inches and a height from 3.0 inches to 5.0 inches.

A prop 30 is attached to the first side 18 surface and extends vertically upwardly to a height dimension greater than a height dimension of the top surface 14 at an apex 32 of the top surface 14 to define a lateral barrier 34 relative to the base 12. The prop 30 will typically have a height from 9.0 inches to 12.0 inches. The prop 30 has an interior surface 36 facing the base 12 and is abuttable against an inner side 38 of the knee 26 of the user 22.

A retention member 40 is attached to the base 12 and the prop 30 to removably extend over the leg 24 to retain the leg 24 on the base 12. The retention member 40 includes a panel 42 being flexible and attached to an upper edge 44 of the prop 30. The panel 42 has an end edge 46 positioned opposite of the prop 30. A coupler 48 releasably attaches a portion of the panel 42 adjacent to the end edge 46 to the base 12. The coupler 48 includes a first mating member 50 attached to the panel 42 and a second mating member 52 attached to the base 12. The second mating member 52 may be positioned on the second surface 20. The coupler 48 may comprise a hook and loop fastener such that the first mating member 50 may be a hook material and the second mating member 52 may be a loop material.

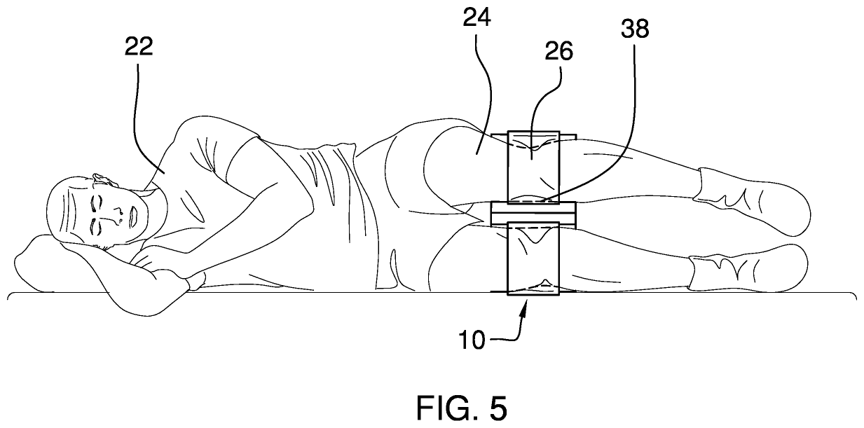

In use, the back 28 of the knee 26 is positioned such that it abuts the top surface 14 of the base 12 to bend the leg 24 and in doing so relieves pressure on the lower back of the user The panel 42 extends over the leg 22 and the coupler 48 attaches the panel 42 to the second surface 20 of the base 12 to retain the leg 24 on the base 12. The leg support pillow 10 will provide continuous support to the leg 24 and the user 22 can change positions when lying down without needing to adjust the leg support pillow 10. As is shown in FIG. 5, the panel(s) 42 is positioned between the user's knees when the user is lying on their side to provide cushioning between the knees to increase comfort for the user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A leg support pillow for removably securing to the back of the knee of a user, said leg support pillow comprising:
a base having a top surface, a bottom surface, a first side surface, and a second side surface, said top surface of said base being configured for abutting and supporting the back of the knee to bend the leg of the user;
a prop being attached to said first side surface and extending vertically upwardly to a height dimension greater than a height dimension of said top surface at an apex of the top surface to define a lateral barrier relative to said base; and
a retention member being attached to said base and said prop to removably extend over the leg to retain the leg on the base.

2. The leg support pillow of claim 1, wherein said top surface is convexly arcuate, said first and second side surfaces each having a semi-circular shape, said base comprising a resiliently compressible material.

3. The leg support pillow of claim 2, wherein said base has a length from 6.0 inches to 9.0 inches, said base having a width from 5.0 inches to 8.0 inches, said base having a height from 3.0 inches to 5.0 inches.

4. The leg support pillow of claim 1, wherein said prop has an interior surface facing said base and being abuttable against an inner side of the knee of the user.

5. The leg support pillow of claim 4, wherein said retention member includes a panel being flexible and attached to an upper edge of said prop, said panel having an end edge positioned opposite of said prop.

6. The leg support pillow of claim 5, further including a coupler releasably attaching a portion of said panel adjacent to said end edge to said base, said coupler including a first mating member attached to said panel and a second mating member attached to said base, said second mating member being positioned on said second surface.

7. A leg support pillow for removably securing to the back of the knee of a user, said leg support pillow comprising:
a base having a top surface, a bottom surface, a first side surface, and a second side surface, said top surface of said base being configured for abutting and supporting the back of the knee to bend the leg of the user, said top surface being convexly arcuate, said first and second side surfaces each having a semi-circular shape, said base comprising a resiliently compressible material, said base having a length from 6.0 inches to 9.0 inches, said base having a width from 5.0 inches to 8.0 inches, said base having a height from 3.0 inches to 5.0 inches;
a prop being attached to said first side surface and extending vertically upwardly to a height dimension greater than a height dimension of said top surface at an apex of the top surface to define a lateral barrier relative to said base, said prop having an interior surface facing said base and being abuttable against an inner side of the knee of the user;
a retention member being attached to said base and said prop to removably extend over the leg to retain the leg on the base, said retention member including:
a panel being flexible and attached to an upper edge of said prop, said panel having an end edge positioned opposite of said prop; and
a coupler releasably attaching a portion of said panel adjacent to said end edge to said base, said coupler including a first mating member attached to said panel and a second mating member attached to said base, said second mating member being positioned on said second surface.
